(19) United States
(12) Patent Application Publication
(10) Pub. No.: US 2005/0197819 A1
(43) Pub. Date: Sep. 8, 2005

(54) System and method for running web applications locally

(76) Inventors: James B. Hopkins, State College, PA (US); Kelly E. Voltz, State College, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 10/792,294

(22) Filed: Mar. 2, 2004

(51) Int. Cl. G06F 9/45

(52) U.S. Cl. 703/22

(57) ABSTRACT

A remote server-based application is executed offline on a local computer by providing a local computer with an application, an application server which executes the application, and an application server manager. The application server manager is used to manage the application server so as to start and stop the application server, thereby starting and stopping the application so that the locally executed application is experienced in the same manner as if the application was executed via a remote server. Multi-user capability of the application server is disabled. The application server manager may be a browser shell. The application may be a simulation engine and the application content may be simulation content.

### COMPACT DISC APPENDIX

This patent application includes an Appendix on one compact disc having a file named appendix.txt, created on Mar. 2, 2004, and having a size of 188,370 bytes. The compact disc is incorporated by reference into the present patent application.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

Computer-assisted educational tools are exploding in popularity, especially in government and corporate continuing education settings. One type of educational tool is a simulation. The general public is most familiar with simulation programs through popular computer video games such as SimCity™ (available from Electronic Arts Inc.) and RollerCoaster Tycoon (available from Atari®, formerly Infogrames Entertainment S.A.). However, simulation programs are now being used in business environments for training and education. For example, a simulation may be used to teach how to read a financial statement and how specific business decisions may impact the balance sheet of a specific company. SimShop™, available from Strategic Management Group, Inc. (SMG), Philadelphia, Pa., is a platform for development, maintenance and deployment of simulations. By enhancing the capabilities of the simulation platform, simulation experiences can be improved and made more flexible. The present invention provides for such enhancements.

Many large applications, such as SimShop simulations, are experienced by users via the World Wide Web (i.e., the Web). The Web allows information to be accessed over the Internet. The Web is an information-sharing model that is built on top of the Internet. The Web uses the HTTP protocol to transmit data. The Web also uses browsers, such as Internet Explorer or Netscape, to access Web documents called Web pages that are linked to each other via hyperlinks. Web documents may contain graphics, sounds, text and video.

FIG. 1 shows a typical implementation for experiencing a web-based application, such as SimShop. A user's local computer 10 connects to a remote server 12 via the Web 14 by using a browser 16 in the local computer 10. The remote server 12 includes an application 18, such as a simulation engine, an application server 20 and application content 22. The application server 20 includes application server software 23, a database 24 and a web server 26. The application content 22 may include application files. In a simulation application, such as SimShop, the application content 22 includes simulation files, such as Flash® movies, image and video files. The database 24 may include application data. In SimShop, the database 24 includes simulation data such as textual content and simulation flows, as well as user admin and runtime information.

It would be desirable to allow applications that are normally executed in this manner to be executed offline on a local computer. In this manner, a user may experience the application without needing to connect to a remote server. The present invention fulfills this need.

### BRIEF SUMMARY OF THE INVENTION

A remote server-based application is executed offline on a local computer by providing a local computer with an application, an application server which executes the application, and an application server manager, The application server manager is used to manage the application server so as to start and stop the application server, thereby starting and stopping the application so that the locally executed application is experienced in the same manner as if the application was executed via a remote server.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. However, the invention is not limited to the precise arrangements and instrumentalities shown.

In the drawings:

FIG. 1 is a schematic block diagram showing how a local computer remotely accesses a web application in accordance with the prior art.

FIG. 2 is a schematic block diagram showing how a local computer accesses the web application of FIG. 1 without any remote access, in accordance with a preferred embodiment of the present invention.

### DETAILED DESCRIPTION OF THE INVENTION

Certain terminology is used herein for convenience only and is not to be taken as a limitation on the present invention.

The present invention is described in the context of the SimShop™ platform described above. However, the scope of the present invention is not limited to any particular simulation platform or any particular application. Non-simulation applications can also take advantage of the present invention which allows any web application to be run locally.

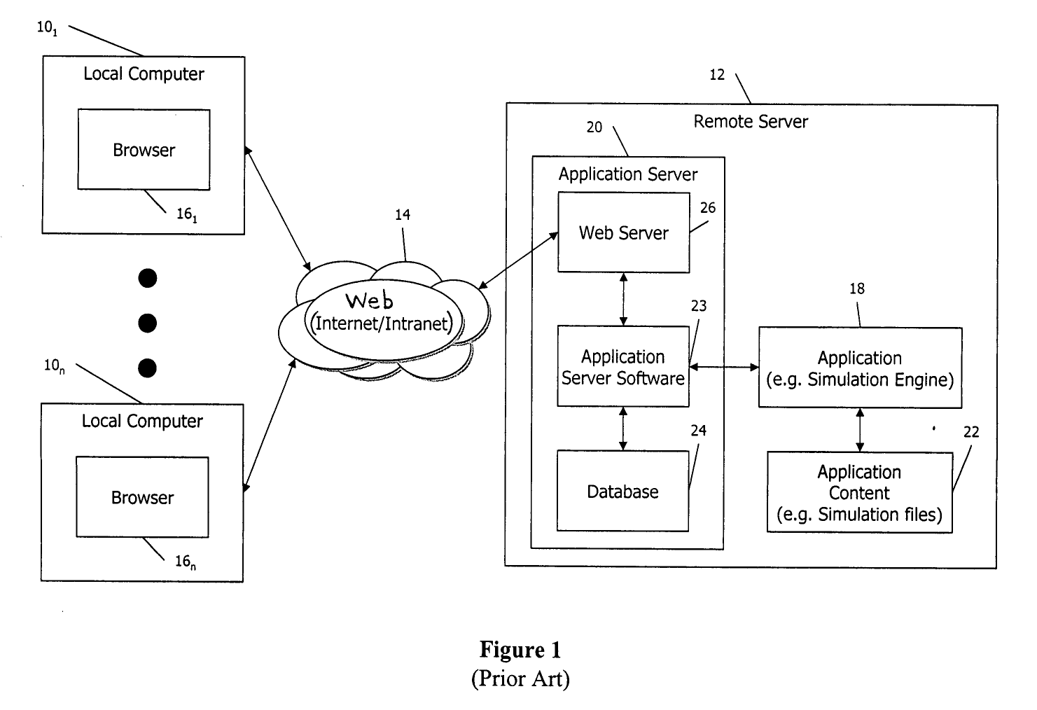

A method and system is provided for executing a remote server-based application offline on a local computer. FIG. 1 shows one preferred embodiment for implementing the method and system. A local computer 30 is provided with an application 32, an application server 34 which executes the application 32, an application (server) manager 36, and application content 38 for use by the application 32. The application manager 36 manages the application server 34 so as to start and stop the application server 34, thereby starting and stopping the application 32 so that the locally executed application 32 is experienced in the same manner as if the application 32 was executed via a remote server, such as the remote server 12 shown in FIG. 1. The application server 34 includes application server software 39, database 40 and web server 42. The application content 38 may include application files.

In one preferred embodiment of the present invention, the application 32 is a simulation engine and the application content 38 includes simulation files such as Flash® movies, image and video files. The database 40 may include application data. In SimShop, the database 40 includes simulation data such as textual content and simulation flows, as well as user admin and runtime information.

In one preferred embodiment of the present invention, the application manager 36 is a browser shell application which includes a browser and software for managing the application server 34.

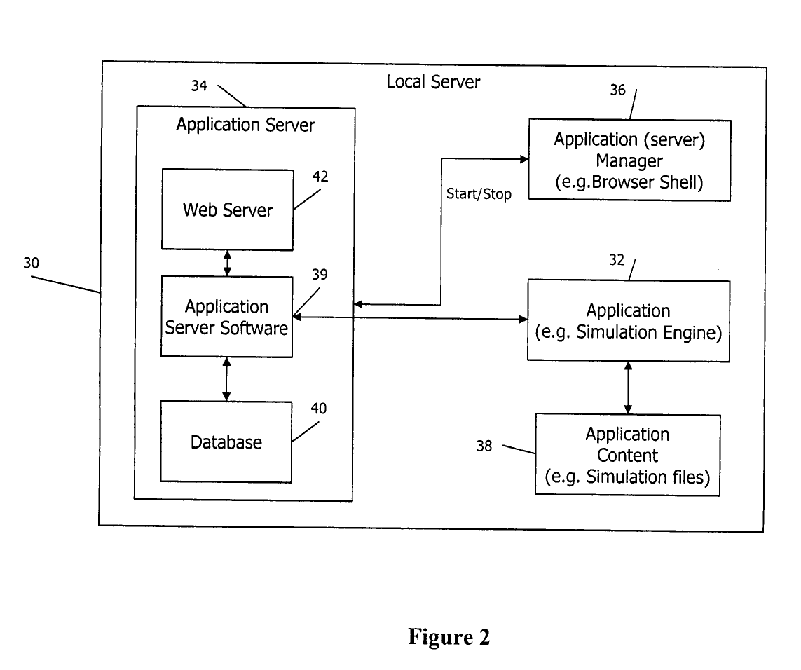

The embodiment shown in FIG. 2 is not merely a rearrangement of the elements of the remote server 12 of FIG. 1 into the local computer 30. To allow for the application to be executed locally, an application manager 36 must be provided which does not exist in the FIG. 1 scheme. The application manager 36 provides a familiar interface for the user, and controls the starting and stopping of the application server 34. The application manager 36 also provides the display capabilities. If the application manager 36 is a browser shell, the browser provides the display capabilities. Alternatively, the application manager 36 may be a browser application, wherein logic for the application manager 36 is embedded in a plug-in. Other techniques for implementing the application manager 36 are within the scope of the present invention.

Also, in a conventional web-based scheme, the application server 34 has multi-user capabilities. However, when used implementing the FIG. 2 scheme, the multi-user capability of the application server is disabled. Effectively, the local computer 30 is provided with server-type capabilities, but with a single user.

One example of pseudocode for an application manager 36 in the form of a browser shell application is as follows:

BEGIN PSEUDOCODE
On application startup
If this application is running
Then
bring existing application to the foreground and exit.
Display Splash screen
If application server is running
Then
connect to existing application
else

start the application server
loop until application server responds

request test page

end loop

initialize browser window
wait for events and execute browser functions
On application exit
Send shutdown message to application server
Wait until application server is shutdown
Exit
END PSEUDOCODE

The Appendix provides one embodiment of source code for implementing the pseudocode.

In the conventional embodiment of FIG. 1, the application server software 23 may be WebLogic® application server software, available from BEA Systems, Inc. One suitable application server software 39 for use in the present invention is JBoss application server software. JBoss is open-source J2EE (Java) application server software. However, other application server software may be used as well. For example, WebLogic may be used with the multiuser capability disabled, however this implementation would be an extremely expensive solution for a local computer such as a PC or laptop.

In the conventional embodiment of FIG. 1, the database 24 may use Microsoft SQL Server. One suitable database 40 for use in the present invention uses Hypersonic SQL, which is an open-source database written in Java. Hypersonic SQL operates in one of three modes: in-memory, standalone (one application accesses the database exclusively), and client/server. In one preferred embodiment of the present invention, Hypersonic SQL is preferably operated in the standalone mode. The JBoss server defaults to the Hypersonic SQL database server upon startup.

One suitable web server 42 for use in the present invention is Jetty, which is an open-source web server (copyright owner—Mort Bay Consulting Pty. Ltd. (Australia)). However, other web servers may be used.

By using compact, efficient, open source programs such as JBoss, Hypersonic SQL and Jetty, the time and expense of distributing the simulations to a plurality of separate, untethered computers is minimized. The entire application server 34, including the database 40, web server 42, and application server software 39 can even be easily downloaded when using such programs.

One benefit of the present invention is that by untethering simulation sessions from a remote server, simulation sessions can be conducted anywhere that a user may located. The user merely needs a computer, such as a laptop computer, and the preinstalled software to experience the simulation.

After a session is completed, the results of the simulation, such as a player score, may be uploaded to an on-line version of the simulation.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

1. A method of executing a remote server-based application offline on a local computer, the method comprising:
(a) providing on the local computer:
(i) an application,
(ii) an application server which executes the application, and
(iii) an application server manager;
(b) using the application server manager to manage the application server so as to start and stop the application server, thereby starting and stopping the application so that the locally executed application is experienced in the same manner as if the application was executed via a remote server.

2. The method of claim 1 wherein the local computer further provides:
(iv) application content for use by the application.

3. The method of claim 2 wherein the application is a simulation engine and the application content is simulation content.

4. The method of claim 1 wherein the application server manager is a browser shell.

5. The method of claim 4 wherein the browser shell includes:
(A) a browser, and
(B) software for managing the application server.

6. The method of claim 1 wherein the application server manager is a browser application and the logic for the application server manager is embedded in a plug-in application.

7. The method of claim 1 wherein the application is a simulation engine.

8. The method of claim 1 further comprising:
(c) disabling any multi-user capability of the application server.

9. A local computer which executes a remote server-based application offline, the local computer comprising:
(a) an application,
(b) an application server which executes the application, and
(c) an application server manager, the application server manager managing the application server so as to start and stop the application server, thereby starting and stopping the application so that the locally executed application is experienced in the same manner as if the application was executed via a remote server.

10. The local computer of claim 9 further comprising:
(d) application content for use by the application.

11. The local computer of claim 10 wherein the application is a simulation engine and the application content is simulation content.

12. The local computer of claim 9 wherein the application server manager is a browser shell.

13. The local computer of claim 12 wherein the browser shell includes:
(i) a browser, and
(ii) software for managing the application server.

14. The local computer of claim 9 wherein the application server manager is a browser application and the logic for the application server manager is embedded in a plug-in application.

15. The local computer of claim 9 wherein the application is a simulation engine.

16. The local computer of claim 9 wherein any multi-user capability of the application server is disabled.

17. An article of manufacture for executing a remote server-based application offline on a local computer which includes (i) an application, (ii) an application server which executes the application, and (iii) an application server manager, the article of manufacture comprising a computer-readable medium holding computer-executable instructions to allow the application server manager to manage the application server so as to start and stop the application server, thereby starting and stopping the application so that the locally executed application is experienced in the same manner as if the application was executed via a remote server.

18. The article of manufacture of claim 17 wherein the application is a simulation engine and the local computer further provides simulation content for the use by the simulation engine.

19. The article of manufacture of claim 17 wherein the application server manager is a browser shell and the computer-executable instructions implement a browser and manage the application server.

20. The article of manufacture of claim 17 wherein the application server manager is a browser application and the computer-executable instructions are embedded in a plug-in application.

21. The article of manufacture of claim 17 wherein the computer-executable instructions perform a method further comprising disabling any multi-user capability of the application server.
